(19) United States
(12) Patent Application Publication
(10) Pub. No.: US 2026/0213924 A1
(43) Pub. Date: Jul. 23, 2026

(54) SECURE WORKLOAD DEPLOYMENT

(71) Applicant: Dell Products L.P., Round Rock, TX (US)

(72) Inventors: Kah Wai Au, Singapore (SG); Jia Yuan Chia, Singapore (SG)

(21) Appl. No.: 19/028,836

(22) Filed: Jan. 17, 2025

(51) Int. Cl. H04L 9/08; H04L 9/40; H04L 67/1012

(52) U.S. Cl. CPC H04L 9/0825; H04L 9/40; H04L 67/1012

(57) ABSTRACT

Methods, apparatus, and processor-readable storage media for secure workload deployment are provided herein. An example computer-implemented method includes obtaining, at a primary device, a public key corresponding to a secondary device, wherein the public key is obtained from a processor-based orchestrator, via a secure communication channel, in a distributed computing environment. The method includes initiating, by the primary device, an attestation process at the secondary device based at least in part on the public key, wherein the attestation process obtains information corresponding to a configuration of the secondary device, and causing the secondary device to execute a first workload from among a plurality of workloads based at least in part on a result of the attestation process.

### BACKGROUND

Device requirements in computing environments are constantly evolving as new technologies are introduced. Existing devices in such computing environments often fail to meet these evolving requirements.

### SUMMARY

Illustrative embodiments of the disclosure provide techniques for secure workload deployment. An exemplary computer-implemented method includes obtaining, at a primary device, a public key corresponding to a secondary device, wherein the public key is obtained from a processor-based orchestrator, via a secure communication channel, in a distributed computing environment. The method includes initiating, by the primary device, an attestation process at the secondary device based at least in part on the public key, wherein the attestation process obtains information corresponding to a configuration of the secondary device, and causing the secondary device to execute a first workload from among a plurality of workloads based at least in part on a result of the attestation process

Illustrative embodiments can provide significant advantages relative to conventional techniques. For example, technical problems associated with utilizing devices in distributed computing architectures are mitigated in one or more embodiments by securely onboarding a primary device, such as a computing endpoint, that acts as a hub for deploying at least some workloads to one or more secondary devices. Such embodiments can effectively preserve computing resources of the primary device for certain types of workloads (e.g., workloads satisfying a designated priority threshold and/or security threshold), while efficiently utilizing resources of the secondary devices.

As another example, some embodiments can improve resource allocation and scalability by offloading particular types of workloads to secondary devices, while maintaining the security posture of the trusted primary devices and ensuring workloads involving sensitive and/or higher priority data are properly managed.

These and other illustrative embodiments described herein include, without limitation, methods, apparatus, systems and computer program products comprising processor-readable storage media.

### BRIEF DESCRIPTION OF THE DRAWINGS

FIG. 1 shows an information processing system configured for secure workload deployment in an illustrative embodiment.

FIG. 2 shows a distributed architecture in an illustrative embodiment.

FIG. 3 shows a flow diagram of an onboarding process in an illustrative embodiment.

FIG. 4 shows a flow diagram of an attestation process in an illustrative embodiment.

FIG. 5 shows a flow diagram of a deployment process in an illustrative embodiment.

FIG. 6 shows a flow diagram of a process for secure workload deployment in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

As new technologies emerge, the requirements for computing environments frequently change. Updating existing devices to meet these new requirements is often difficult, if not technically impossible due to hardware constraints, for example. Accordingly, organizations typically decide between investing in new, compatible devices or foregoing the advantages offered by the latest technological advancements.

The term “primary device,” as used herein, is intended to be broadly construed so as to include any device that satisfies a designated level of security and is capable of performing computational tasks, data storage and/or network communication within a distributed computing environment. In some embodiments, such functions are assumed to be performed closer to a source of data generation to reduce latency, enhance data privacy and optimize resource utilization within the distributed computing environment. As a non-limiting example, a primary device may serve as a computing endpoint in an edge computing architecture, where the primary device operates with secure communication protocols established with at least one other entity in the edge computing environment, such as an edge orchestrator.

The term “secondary device” as used herein is intended to be broadly construed, so as to encompass, for example, devices that may not natively support integration into a distributed computing environment but can be adapted or interfaced to contribute to such systems. As non-limiting examples, a secondary device may include a brownfield device, a legacy device and/or existing hardware and/or software solutions. In some embodiments, secondary devices may lack the capability of establishing secure communication with an edge orchestrator, for example.

In the context of distributed computing environments, such as edge computing environments, these challenges can be particularly problematic due to the number of devices and the complexity of such environments. For example, in an edge computing environment, Edge Compute Endpoints (ECEs) often operate under significant resource constraints with limited processing power and memory. Deploying resource-intensive applications or performing frequent updates can quickly exhaust the limited capacity of an ECE. Moreover, edge devices often face stringent security demands. For example, maintaining a trusted environment and protecting sensitive data on edge devices often necessitates the use of Trusted Execution Environments (TEEs) and robust remote attestation mechanisms to verify device integrity. The process of integrating advanced security measures into older, less capable devices can be technically challenging and can compromise performance and/or introduce new security vulnerabilities in such devices. Accordingly, there are significant technical challenges to efficiently leverage existing device resources without sacrificing security and/or functionality.

Some embodiments described herein include securely onboarding a primary device (e.g., an edge computing endpoint) that acts as a hub for deploying at least some workloads to one or more secondary devices (e.g., legacy or brownfield devices). Such embodiments can effectively preserve computing resources of the primary device for certain types of workloads (e.g., workloads satisfying a designated priority threshold and/or security threshold), while efficiently utilizing resources of the secondary devices for executing other workloads (e.g., non-critical workloads or workloads requiring less security), thereby improving overall system performance and reducing the need for additional hardware investments.

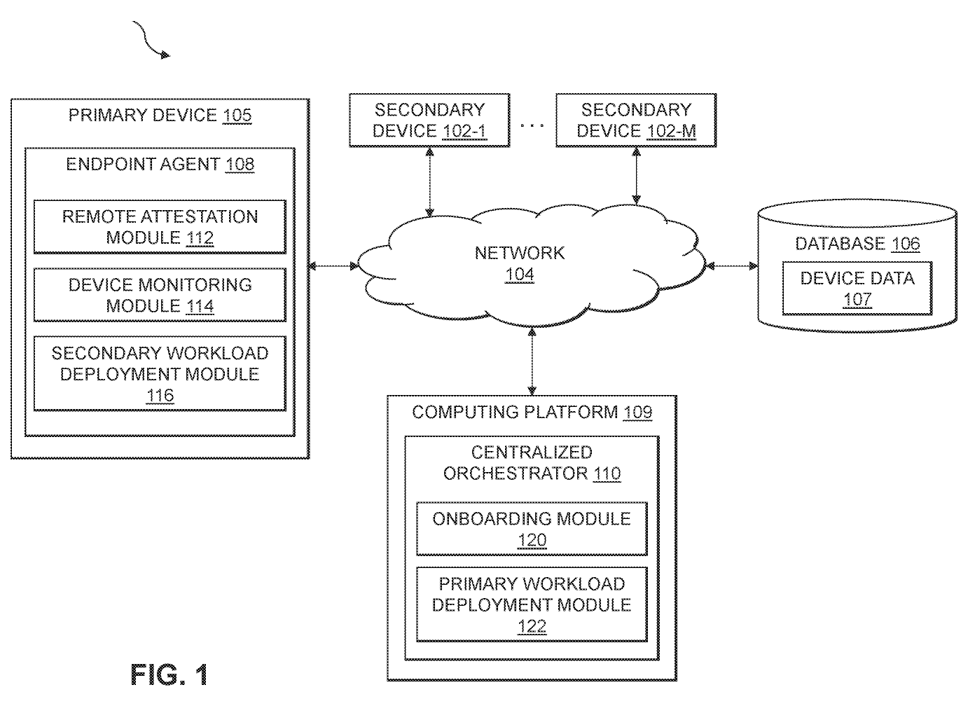

FIG. 1 shows a computer network (also referred to herein as an information processing system) 100 configured in accordance with an illustrative embodiment. The computer network 100 comprises a plurality of secondary devices 102-1 . . . 102-M, collectively referred to herein as secondary devices 102. The secondary devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 are at least one primary device 105 and at least one computing platform 109 comprising a centralized orchestrator 110.

The secondary devices 102 and/or the primary device 105 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The secondary devices 102 and/or the primary device 105 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

The secondary devices 102 and/or the primary device 105 in some embodiments can be associated with one or more users. It is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the primary device 105 and/or the computing platform 109 can have at least one associated database 106 configured to store device data 107 pertaining to, for example, security information, address information and/or attestation data associated with one or more of the secondary devices 102.

An example database 106, such as depicted in the present embodiment, can be implemented using one or more storage systems associated with the primary device 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the primary device 105 are one or more input-output devices, which illustratively comprise keyboards, displays or other types of input-output devices in any combination. Such input-output devices can be used, for example, to support one or more user interfaces to the primary device 105, as well as to support communication between primary device 105 and other related systems and devices not explicitly shown.

Additionally, the primary device 105 in the FIG. 1 embodiment is assumed to be implemented using at least one processing device. Each such processing device generally comprises at least one processor and an associated memory, and implements one or more functional modules for controlling certain features of the primary device 105.

More particularly, the primary device 105 in this embodiment can comprise a processor coupled to a memory and a network interface.

The processor illustratively comprises a microprocessor, a microcontroller, an application-specific integrated circuit (ASIC), a field-programmable gate array (FPGA) , a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the primary device 105 to communicate over the network 104 with the secondary devices 102 and/or the at least one computing platform 109, and illustratively comprises one or more conventional transceivers.

The centralized orchestrator 110, in some embodiments, can be deployed on the at least one computing platform 109, which may correspond to one or more data centers and/or a cloud computing environment, as non-limiting examples. Generally, the computing platform 109 comprises infrastructure and/or resources for supporting the operation of the centralized orchestrator 110. As used herein, the term “centralized orchestrator” shall be broadly construed to encompass, for example, an orchestrator (also referred to as a processor-based orchestrator) that is accessible to both primary and secondary devices, and should not be construed to require any particular locational relationship relative to the primary and secondary devices, as would be apparent to a person of ordinary skill in the art.

In the FIG. 1 embodiment, the centralized orchestrator 110 includes an onboarding module 120 and a primary workload deployment module 122. The onboarding module 120 generally includes functionality for securely onboarding devices, such as the primary device 105. For example, the onboarding module 120 can be configured to manage secure connections (e.g., TLS (Transport Layer Security)), authentication mechanisms and access controls to ensure interactions between components in a distributed computing environment adhere to security policies and standards, for example. As a non-limiting example, the at least one primary device 105 can correspond to at least one edge device within an edge computing environment, and the centralized orchestrator 110 can be configured to onboard and/or manage the at least one primary device 105 within the edge computing environment using its onboarding module 120 and primary workload deployment module 122.

In at least one embodiment, the onboarding module 120 can further include functionality for providing a user interface or portal where users (e.g., system administrators) can provide information for configuring the primary device 105 and/or the secondary devices 102. For example, the onboarding module 120 can implement a secure onboarding process to establish a trusted communication channel between the centralized orchestrator 110 and the primary device 105 using one or more authentication standards, as explained in more detail elsewhere herein. The primary workload deployment module 122 generally includes functionality for coordinating deployment, management and monitoring of workloads associated with the at least one primary device 105.

It is to be appreciated that this particular arrangement of elements 110, 120 and 122 illustrated in the computing platform 109 of the FIG. 1 embodiment is presented by way of example only, and alternative arrangements can be used in other embodiments. For example, the functionality associated with the elements 110, 120 and 122 in other embodiments can be combined into a single module or separated across a larger number of modules. As another example, multiple distinct processors can be used to implement different ones of the elements 110, 120 and 122 or portions thereof.

At least portions of elements 110, 120 and 122 may be implemented at least in part in the form of software that is stored in memory and executed by a processor.

In some embodiments, the primary device 105 acts as a hub for deploying workloads to one or more of the secondary devices 102. For example, the primary device 105 in the FIG. 1 embodiment includes an endpoint agent 108 comprising a remote attestation module 112, a device monitoring module 114 and a secondary workload deployment module 116.

The remote attestation module 112 generally can verify the integrity of one or more of the secondary devices 102 and ensure that the secondary devices 102 are in a designated state for processing workloads. In some embodiments, the remote attestation module 112 may obtain information associated with the secondary devices 102 to create attestation records. The attestation records, in some embodiments, may include platform configuration register (PCR) measurements, snapshots of hardware configurations and/or software configurations, and results of one or more security scans. The attestation records can be stored in the at least one database 106 as device data 107, for example. In some embodiments, the remote attestation module 112 generates a trusted attestation record for a given one of the secondary devices 102, where the trusted attestation record corresponds to a known state of the given one of the secondary devices 102.

The device monitoring module 114 generally includes functionality for monitoring the health, status and/or security posture of the secondary devices 102. For example, the device monitoring module 114 may compare current attestation records to trusted attestation records generated to ensure that the secondary devices 102 remain in known states. In some embodiments, the device monitoring module 114 can send an alert to the centralized orchestrator 110 based on the results of the monitoring.

The secondary workload deployment module 116 manages deployment of workloads from the primary device 105 to the secondary devices 102. The secondary workload deployment module 116 can ensure that workload instructions are executed correctly on the secondary devices while maintaining security and integrity, as described in more detail elsewhere herein.

It is to be appreciated that this particular arrangement of elements 108, 112, 114 and 116 illustrated in the primary device 105 of the FIG. 1 embodiment is presented by way of example only, and alternative arrangements can be used in other embodiments. For example, the functionality associated with the elements 108, 112, 114 and 116 in other embodiments can be combined into a single module or separated across a larger number of modules. As another example, multiple distinct processors can be used to implement different ones of the elements 108, 112, 114 and 116 or portions thereof.

At least portions of elements 108, 112, 114 and 116 may be implemented at least in part in the form of software that is stored in memory and executed by a processor.

It is to be understood that the particular set of elements shown in FIG. 1 for primary device 105 involving secondary devices 102 and the centralized orchestrator 110 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the primary device 105, the centralized orchestrator 110 and database 106 can be on and/or part of the same processing platform.

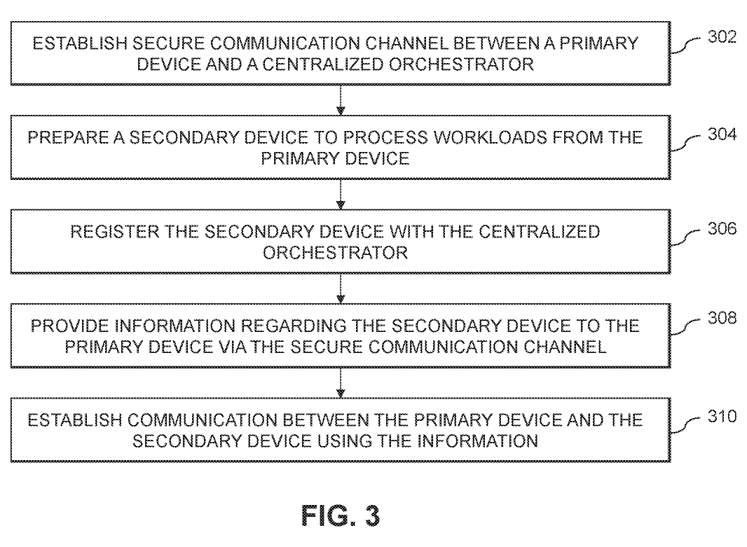

An exemplary process utilizing elements 112, 114 and 116 of an example primary device 105 in computer network 100 will be described in more detail with reference to, for example, the flow diagrams of FIGS. 3-6.

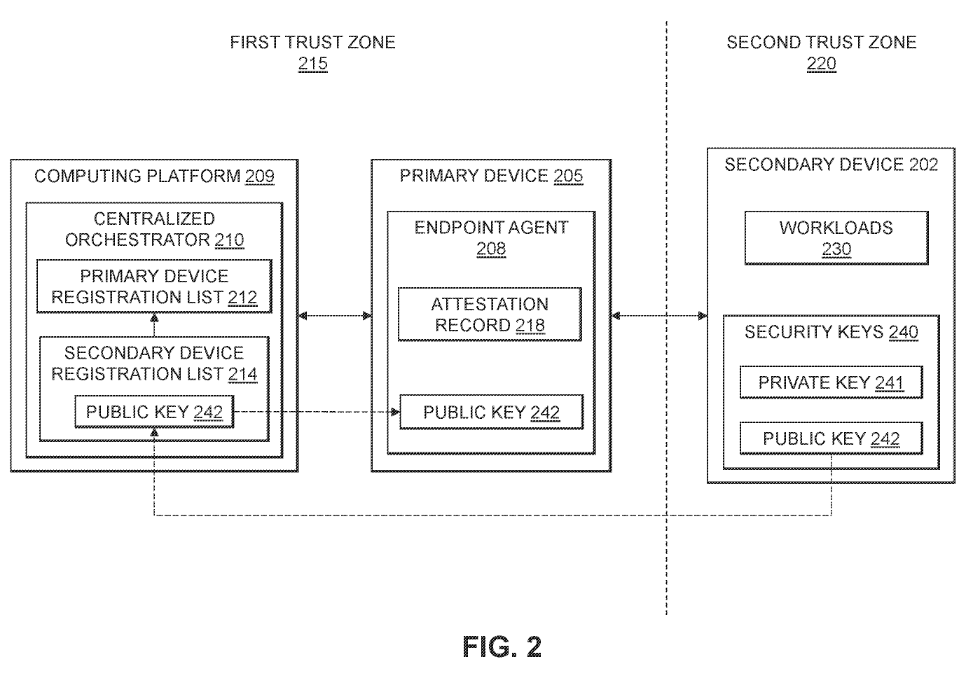

FIG. 2 shows a distributed architecture comprising a primary device 205, a secondary device 202 and a computing platform 209, in an illustrative embodiment. The primary device 205, the secondary device 202 and the computing platform 209 may respectively correspond to the primary device 105, the secondary device 102-1 and the computing platform 109, for example.

The computing platform 209 includes a centralized orchestrator 210 configured for maintaining two registration lists: a primary device registration list 212 and a secondary device registration list 214.

The primary device registration list 212 includes entries for primary devices that have been registered with the centralized orchestrator 210, while the secondary device registration list 214 includes entries for registered secondary devices. Each secondary device in the secondary device registration list 214 can be associated with a corresponding one of the primary devices that are included in the primary device registration list 212. In some embodiments, multiple secondary devices can be associated with a given one of the primary devices. For example, the primary device registration list 212 can be updated or modified when a new primary device is successfully onboarded. Similarly, the secondary device registration list 214 can be updated or modified when a new secondary device is onboarded and linked to one of the primary devices.

In the FIG. 2 example, it is assumed that the primary device 205 has been successfully onboarded and added to the primary device registration list 212. As described in more detail below in conjunction with FIG. 3, the onboarding process establishes a secure communication channel between the primary device 205 and the centralized orchestrator 210, and the centralized orchestrator 210 and the primary device 205 are considered part of a first trust zone 215.

The secondary device 202 can then be registered with the centralized orchestrator 210 based on a pair of security keys 240 including a private key 241 and a public key 242. For example, the security keys 240 can be generated at the secondary device 202. The public key 242 can then be provided (e.g., by a user) to the centralized orchestrator 210. Additional information related to the secondary device 202 can also be provided to the centralized orchestrator 210, such as an identifier and/or network address of the secondary device 202. For example, the private key 241 and public key 242 can correspond to cryptographic keys, such as Secure Shell (SSH) protocol keys. The centralized orchestrator 210 can then provide the public key 242 to the primary device 205. The dashed arrows in FIG. 2 represent the exchange of the public key 242 between the secondary device 202, the centralized orchestrator 210 and the primary device 205.

After receiving the public key 242, the primary device 205 can cause an initial remote attestation process to be performed at the secondary device 202 using the public key 242. The initial remote attestation process can collect information related to hardware and/or software configurations of the secondary device 202, PCR measurements, and/or results of security scans. This information is stored in an attestation record 218. The attestation record 218 corresponds to a known state of the secondary device 202 that is assumed to be secure. The secondary device 202 is considered as being within a second trust zone 220, where the second trust zone 220 is assumed to be less secure than the first trust zone 215. For example, the first trust zone 215 can be a trusted zone, whereas the second trust zone 220 can be a partially trusted zone.

In some embodiments, the primary device 205 comprises an endpoint agent 208 that obtains workload deployment instructions from the centralized orchestrator 210. The endpoint agent 208 can determine whether or not to offload at least some of the workloads to the secondary device 202. For example, the endpoint agent 208 can deploy one or more workloads 230 to be executed by the secondary device 202 based on one or more user inputs obtained by the centralized orchestrator 210, workload types and/or workload priorities. Generally, the workloads 230 to be executed by the secondary device 202 correspond to workloads that require less security and/or have a lower priority. As a non-limiting example, workloads involving confidential and/or sensitive information (e.g., payment card information) may be performed only at the primary device 205, whereas other workloads may be deployed to the secondary device 202.

In some embodiments, a user can provide one or more inputs via a user interface corresponding to the centralized orchestrator 210 to indicate whether a given workload can be offloaded to the secondary device 202 and/or to specify criteria for offloading the given workload. In some embodiments, the inputs may be provided as part of a deployment request.

It is to be appreciated that the public key 242 enables the primary device to access the secondary device 202 without requiring any additional software to be installed on the secondary device 202. By using the public key 242 for access, the commands executed on the secondary device 202 (e.g., deployment and/or attestation commands) are temporary in nature. Optionally, the primary device 205 can initiate a cleanup process following execution of the commands to remove any residual data or processes created by such commands.

In some embodiments, no direct communication is allowed between the secondary device 202 and the centralized orchestrator 210 to maintain the security posture between the centralized orchestrator 210 and the primary device 205.

FIG. 3 shows an onboarding process in an illustrative embodiment. It is to be understood that this particular onboarding process is only an example, and additional or alternative onboarding processes can be carried out in other embodiments. In this embodiment, the onboarding process includes steps 302 through 310.

Step 302 includes establishing a secure communication channel between a primary device (e.g., the primary device 205) and a centralized orchestrator (e.g., centralized orchestrator 210). For example, the secure communication channel can be established based on one or more authentication protocols, such as FIDO (Fast IDentity Online) protocols.

Step 304 includes preparing a secondary device (e.g., secondary device 202) to process workloads from the primary device. For example, step 304 may include scanning the secondary device to ensure it is secure.

Step 306 includes registering the secondary device with the centralized orchestrator. For example, a public key and a private key can be generated for the secondary device, and the public key can be provided to the centralized orchestrator along with an address (e.g., an Internet Protocol (IP) address) of the secondary device.

Step 308 includes providing information regarding the secondary device to the primary device 205 via the secure communication channel established in step 302. For example, the centralized orchestrator can provide the public key and the address of the secondary device to the primary device.

Step 310 includes establishing communication between the primary device and the secondary device using the information. For example, in embodiments where the public key corresponds to a public SSH key, the primary device can use the public SSH key to communicate with the secondary device using the SSH protocol.

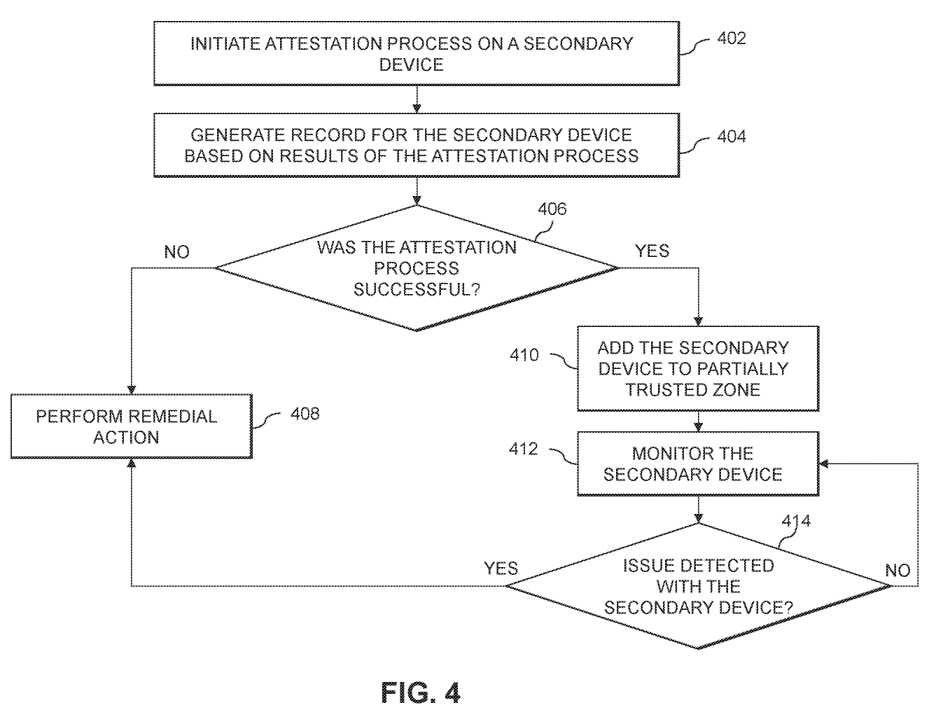

Referring now to FIG. 4, this figure shows a flow diagram of an attestation process in an illustrative embodiment. It is to be understood that this particular attestation process is only an example, and additional or alternative attestation processes can be carried out in other embodiments. In this embodiment, the attestation process includes steps 402 through 414.

Step 402 includes initiating an attestation process on a secondary device. As noted above, the attestation process can include collecting PCR measurements of the secondary device to ensure that the device is booting into a known environment, snapshots of the hardware configurations and/or snapshots of applications executing on the secondary device. In other embodiments, the attestation process can be configured and/or modified by a user to include alternative or additional information depending on the use case.

Step 404 includes generating an attestation record for the secondary device based on the results of the attestation process.

Step 406 includes a test to determine whether the attestation process was successful. In some embodiments, the test in step 406 can verify that all of the necessary information was successfully collected by the primary device and that the information satisfies at least a designated security threshold. As a non-limiting example, the security threshold can be based on software requirements (e.g., a list of allowed applications and/or a list of prohibited applications) and/or hardware requirements.

If the result of the test in step 406 is no, then step 408 includes performing one or more remedial actions. For example, the remedial actions may include quarantining the secondary device to prevent the secondary device from executing workloads, causing one or more alerts to be sent to one or more users, initiating a software update for the secondary device, removing one or more applications from the secondary device and/or restarting the secondary device.

If the result of the test in step 406 is yes, then step 410 is performed. Step 410 includes adding the secondary device to a partially trusted zone (e.g., the second trust zone 220). In some embodiments, a user can be provided an option to add the secondary device to the partially trusted zone even if the result of the test in step 406 is no.

Step 412 includes monitoring the secondary device. For example, the monitoring can include performing one or more subsequent attestation processes to ensure that the secondary device remains in a known state.

Step 414 includes a test to determine whether any issue has been detected with the secondary device. For example, the test in step 414 can include comparing the results of one or more subsequent attestation processes to the results of an initial attestation process, where the initial attestation process was performed when the secondary device was in a known state. If the result of step 414 is no, then the process returns to step 412. If the result of step 414 is yes, then the process continues to step 408 to perform one or more remedial actions.

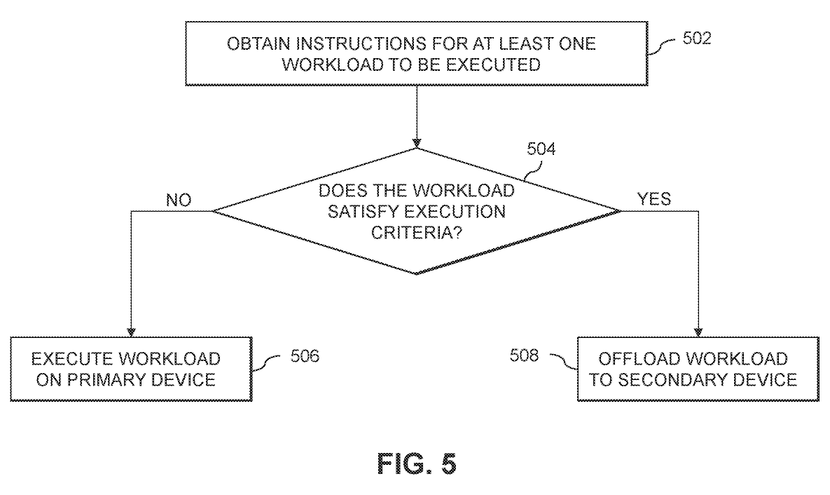

FIG. 5 shows a deployment process in an illustrative embodiment. It is to be understood that this particular deployment process is only an example, and additional or alternative deployment processes can be carried out in other embodiments. In this embodiment, the onboarding process includes steps 502 through 508.

Step 502 includes obtaining instructions for at least one workload to be executed.

Step 504 includes a test to determine whether the workload satisfies one or more execution criteria. For example, the execution criteria can be based on a type of the workload, a priority of the workload and/or whether a user specified that the workload can be offloaded to the secondary device.

If the result of step 504 is no, then step 506 is performed, which includes executing the workload on the primary device. If the result of step 504 is yes, then step 508 is performed, which includes offloading the workload to the secondary device.

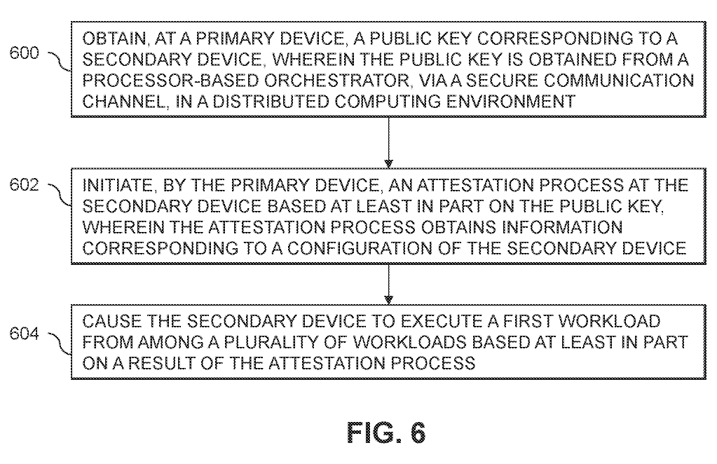

FIG. 6 is a flow diagram of a process for secure workload deployment in an illustrative embodiment. It is to be understood that this particular process is only an example, and additional or alternative processes can be carried out in other embodiments.

In this embodiment, the process includes steps 600 through 604. These steps are assumed to be performed by the primary device 105 utilizing its endpoint agent 108.

Step 600 includes obtaining, at a primary device, a public key corresponding to a secondary device, wherein the public key is obtained from a processor-based orchestrator, via a secure communication channel, in a distributed computing environment.

Step 602 includes initiating, by the primary device, an attestation process at the secondary device based at least in part on the public key, wherein the attestation process obtains information corresponding to a configuration of the secondary device.

Step 604 includes causing the secondary device to execute a first workload from among a plurality of workloads based at least in part on a result of the attestation process.

The primary device may include a first set of security features, and the secondary device may include a second set of security features, where the second set of security features provides a lower level of security than the first set of security features.

The processor-based orchestrator and the primary device may be registered to a trusted zone of the distributed computing environment, and the secondary device may be registered to a partially trusted zone of the distributed computing environment.

The obtaining may further include obtaining at least one network address associated with the secondary device.

The initiating may further include establishing a secure connection with the secondary device based on the public key and a private key generated for the secondary device, where the public key and the private security key correspond to a secure shell protocol.

The process may further include establishing the secure communication channel between the primary device and processor-based orchestrator using one or more cryptographic authentication techniques.

The process may further include generating a first attestation record based on the information obtained by the attestation process, where the first attestation record represents a state of the secondary device at a first time, and monitoring the state of the secondary device based at least in part on a comparison of the first attestation record to at least one second attestation record, where the at least one second attestation record is generated based on at least one additional attestation process, and where the at least one second attestation record represents the state of the secondary device at a second time.

The process may further include identifying at least one anomaly based on the comparison of the first attestation record and the at least one second attestation record and initiating one or more automated actions based on the identified at least one anomaly.

The one or more automated actions may include at least one of preventing the secondary device from executing additional workloads, generating an alert to notify the processor-based orchestrator of the at least one anomaly, performing one or more software updates for the secondary device and initiating one or more security scans on the secondary device. The security scan can include, for example, scanning one or more network ports to identify if any network ports are known to be vulnerable, retrieving a list of running processes and comparing the list of running processes to a list of processes with known security vulnerabilities. The list of processes can be obtained from one or more online sources, such as the Common Vulnerabilities and Exposures (CVE) list. The information corresponding to the configuration of the secondary device may include at least one of a snapshot of at least one software configuration of the secondary device, a snapshot of at least one hardware configuration of the secondary device, one or more platform configuration register measurements corresponding to the secondary device, and results of one or more security scans performed on the secondary device.

Causing the secondary device to execute the first workload may be performed in response to determining that the first workload satisfies one or more execution criteria. The one or more execution criteria may correspond to at least one of a priority of the first workload and one or more types of data associated with the first workload.

The process may further include determining that a second workload from among the plurality of workloads does not satisfy at least one of the one or more execution criteria, and executing the second workload at the primary device.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. Some embodiments enable efficient and secure integration of secondary devices into modern distributed computing architectures. These and other embodiments can effectively overcome technical challenges associated with integrating secondary devices into modern computing environments (e.g., distributed computing environments). For example, some embodiments can improve resource allocation and scalability by offloading particular types of workloads to secondary devices, while maintaining the security posture of trusted primary devices and ensuring that workloads involving sensitive and/or higher priority data are properly managed.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

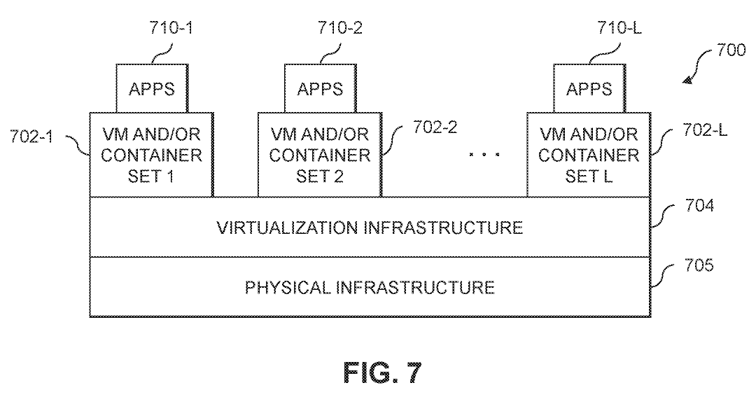

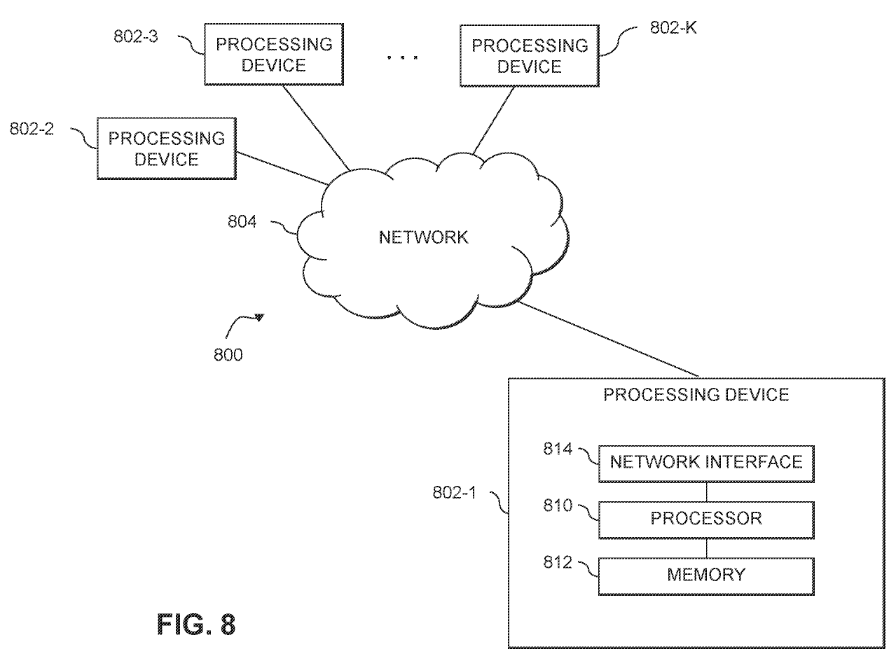

Illustrative embodiments of processing platforms will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, wherein the hypervisor platform has an associated virtual infrastructure management system. The underlying physical machines comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1,802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, a microcontroller, an ASIC, an FPGA, a CPU, a GPU, a TPU, a VPU, an NPU, a DPU, a SOC or other type of processing circuitry, as well as portions or combinations of such circuitry elements.

The memory 812 comprises RAM, ROM or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed computing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining, at a primary device, a public key corresponding to a secondary device, wherein the public key is obtained from a processor-based orchestrator, via a secure communication channel, in a distributed computing environment;
initiating, by the primary device, an attestation process at the secondary device based at least in part on the public key, wherein the attestation process obtains information corresponding to a configuration of the secondary device; and
causing the secondary device to execute a first workload from among a plurality of workloads based at least in part on a result of the attestation process;
wherein the method is performed by at least one processing device comprising a processor coupled to a memory.

2. The computer-implemented method of claim 1, wherein:
the primary device comprises a first set of security features; and
the secondary device comprises a second set of security features, wherein the second set of security features provides a lower level of security than the first set of security features.

3. The computer-implemented method of claim 1, wherein:
the processor-based orchestrator and the primary device are registered to a trusted zone of the distributed computing environment; and
the secondary device is registered to a partially trusted zone of the distributed computing environment.

4. The computer-implemented method of claim 1, wherein the obtaining further comprises:
obtaining at least one network address associated with the secondary device.

5. The computer-implemented method of claim 1, wherein the initiating further comprises:
establishing a secure connection with the secondary device based on the public key and a private key generated for the secondary device, wherein the public key and the private key correspond to a secure shell protocol.

6. The computer-implemented method of claim 1, further comprising:
establishing the secure communication channel between the primary device and process-based orchestrator using one or more cryptographic authentication techniques.

7. The computer-implemented method of claim 1, further comprising:
generating a first attestation record based on the information obtained by the attestation process, wherein the first attestation record represents a state of the secondary device at a first time; and
monitoring the state of the secondary device based at least in part on a comparison of the first attestation record to at least one second attestation record, wherein the at least one second attestation record is generated based on at least one additional attestation process, wherein the at least one second attestation record represents the state of the secondary device at a second time.

8. The computer-implemented method of claim 7, further comprising:
identifying at least one anomaly based on the comparison of the first attestation record and the at least one second attestation record; and
initiating one or more automated actions based on the identified at least one anomaly.

9. The computer-implemented method of claim 8, wherein the one or more automated actions comprise at least one of:
preventing the secondary device from executing additional workloads;
generating an alert to notify the processor-based orchestrator of the at least one anomaly;
performing one or more software updates for the secondary device; and
initiating one or more security scans on the secondary device.

10. The computer-implemented method of claim 1, wherein the information corresponding to the configuration of the secondary device comprises at least one of:
a snapshot of at least one software configuration of the secondary device;
a snapshot of at least one hardware configuration of the secondary device;
one or more platform configuration register measurements corresponding to the secondary device; and
results of one or more security scans performed on the secondary device.

11. The computer-implemented method of claim 1, wherein the causing the secondary device to execute the first workload is performed in response to determining that the first workload satisfies one or more execution criteria, wherein the one or more execution criteria correspond to at least one of:
a priority of the first workload; and
one or more types of data associated with the first workload.

12. The computer-implemented method of claim 11, further comprising:
determining that a second workload from among the plurality of workloads does not satisfy at least one of the one or more execution criteria; and
executing the second workload at the primary device.

13. A non-transitory processor-readable storage medium having stored therein program code of one or more software programs, wherein the program code when executed by at least one processing device causes the at least one processing device:
to obtain, at a primary device, a public key corresponding to a secondary device, wherein the public key is obtained from a processor-based orchestrator, via a secure communication channel, in a distributed computing environment;
to initiate, by the primary device, an attestation process at the secondary device based at least in part on the public key, wherein the attestation process obtains information corresponding to a configuration of the secondary device; and
to cause the secondary device to execute a first workload from among a plurality of workloads based at least in part on a result of the attestation process.

14. The non-transitory processor-readable storage medium of claim 13, wherein:
the primary device comprises a first set of security features; and
the secondary device comprises a second set of security features, wherein the second set of security features provides a lower level of security than the first set of security features.

15. The non-transitory processor-readable storage medium of claim 13, the processor-based orchestrator and the primary device are registered to a trusted zone of the distributed computing environment; and
the secondary device is registered to a partially trusted zone of the distributed computing environment.

16. The non-transitory processor-readable storage medium of claim 13, wherein the obtaining further comprises:
obtaining at least one network address associated with the secondary device.

17. An apparatus comprising:
at least one processing device comprising a processor coupled to a memory;
the at least one processing device being configured:
to obtain, at a primary device, a public key corresponding to a secondary device, wherein the public key is obtained from a processor-based orchestrator, via a secure communication channel, in a distributed computing environment;
to initiate, by the primary device, an attestation process at the secondary device based at least in part on the public key, wherein the attestation process obtains information corresponding to a configuration of the secondary device; and
to cause the secondary device to execute a first workload from among a plurality of workloads based at least in part on a result of the attestation process.

18. The apparatus of claim 17, wherein the primary device comprises a first set of security features; and
the secondary device comprises a second set of security features, wherein the second set of security features provides a lower level of security than the first set of security features.

19. The apparatus of claim 17, wherein the processor-based orchestrator and the primary device are registered to a trusted zone of the distributed computing environment; and
the secondary device is registered to a partially trusted zone of the distributed computing environment.

20. The apparatus of claim 17, wherein the obtaining further comprises:
obtaining at least one network address associated with the secondary device.
